(19) United States
(12) Patent Application Publication
(10) Pub. No.: US 2014/0304076 A1
(43) Pub. Date: Oct. 9, 2014

(54) VARIABLE REWARD OFFERS BASED ON TRAVEL ROUTE

(71) Applicants: Jim S. Baca, Corrales, NM (US); David Stanasolovich, Albuquerque, NM (US); Mark H. Price, Placitas, NM (US)

(72) Inventors: Jim S. Baca, Corrales, NM (US); David Stanasolovich, Albuquerque, NM (US); Mark H. Price, Placitas, NM (US)

(21) Appl. No.: 13/997,199

(22) PCT Filed: Apr. 17, 2012
(86) PCT No.: PCT/US12/33896

§ 371 Date: Mar. 14, 2014

(51) Int. Cl. G06Q 30/02

(52) U.S. Cl. CPC G06Q 30/0261
USPC 705/14.58

(57) ABSTRACT

Generally, this disclosure describes variable reward offers based on travel route. Techniques may include mapping a travel route from a first location to a second location using a mobile device, the mobile device configured to display at least a portion of the travel route; requesting an interest profile from a user, the interest profile comprising a place of interest and a deviation distance; and receiving a reward offer related to the interest profile and the travel route by the mobile device, the reward offer configured to cause the user to deviate a deviation distance from the travel route to redeem the reward.

### FIELD

This disclosure relates to variable reward offers, more particularly variable reward offers based on travel route.

### BACKGROUND

GPS (Global Positioning System)-based systems are commonly used for travel planning and routing. The UPS-based systems may be standalone UPS devices or may be included in other mobile devices, e.g., smartphones, and/or included in an automobile's navigation system. GPS systems may provide some user-selectable options such as shortest route, fastest route, avoiding traffic, etc. Some GPS systems may provide places of interest along a mapped route. Such places of interest may include gas stations, hotels, restaurants, etc., and may be included by virtue of being on a mapped route. Such GPS systems do not typically provide points of interest that are not on the mapped route and are typically ignorant of the user's specific interests.

### BRIEF DESCRIPTION OF THE DRAWINGS

Features and advantages of embodiments of the claimed subject matter will become apparent as the following Detailed Description proceeds, and upon reference to the Drawings, wherein like numerals depict like parts, and in which:

FIG. 1 illustrates a reward offer system consistent with various embodiments of the present disclosure;

FIGS. 2A through 2C illustrate exemplary reward offer systems, each consistent with at least one embodiment of the present disclosure; and

FIG. 3 illustrates a flowchart of exemplary operations consistent with various embodiments of the present disclosure.

Although the following Detailed Description will proceed with reference being made to illustrative embodiments, many alternatives, modifications, and variations thereof will be apparent to those skilled in the art.

### DETAILED DESCRIPTION

Generally, this disclosure describes techniques for providing reward offers, e.g., discount coupons, based on a deviation distance from a mapped travel route. A method and system are configured to provide a user reward offers based on a predefined interest profile while the user is travelling along a mapped route. The interest profile may include a plurality of businesses and/or attractions that are places of interest to the user, Businesses may include, for example, retail businesses, restaurants, etc., and attractions may include historical, recreational and/or tourist attraction, etc. The interest profile may further include an associated deviation distance for each business or attraction. The associated deviation distance corresponds to a distance that the user is willing to travel from a mapped route in order to go to the place of interest (i.e., business or attraction). The deviation distance may be related to a measure of a user's interest in the business or attraction.

The interest profile may include predefined entries that may be user-customizable and/or user defined entries. A predefined interest profile may include generally common user interest profile data. The predefined interest profile may be customizable by a user and/or a user may enter and store a fully custom profile.

An amount of a reward offer may be based, at least in part, on a distance from the mapped route to a place of interest. The reward offers may be time-limited and/or restricted to use by the target user. The reward offers are configured to provide the user incentive to deviate from the mapped route in order to go to a place of interest to the user. The reward offers are further configured to provide a targeted and extended advertising opportunity for businesses to attract travelers who are on a route that does not directly go by their businesses. Thus, both the user and the business may benefit from a method and system consistent with the present disclosure.

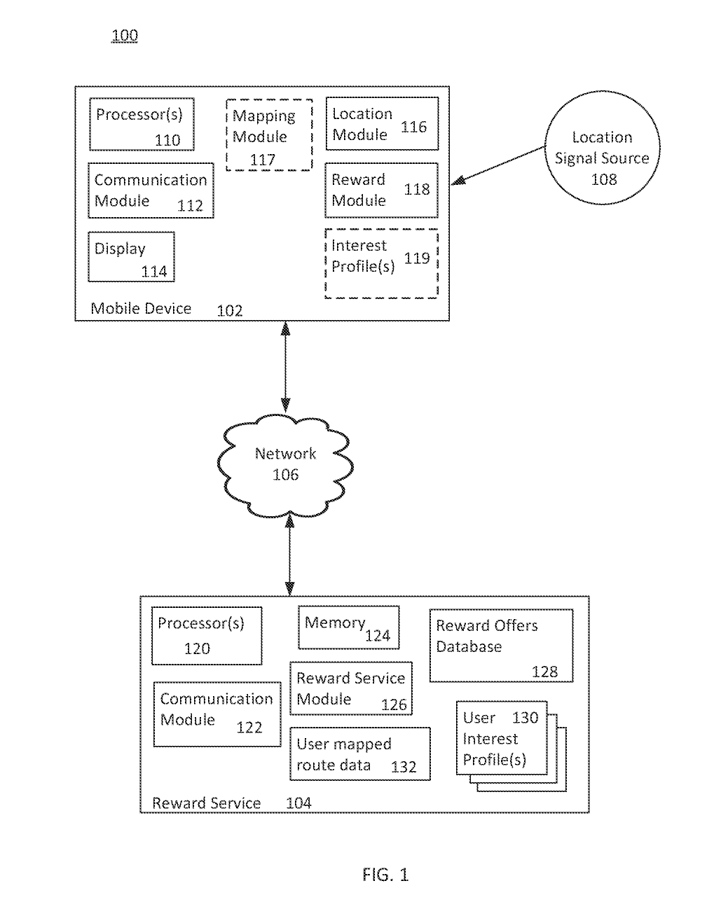

FIG. 1 illustrates a reward offer system 100 consistent with various embodiments of the present disclosure. The system 100 generally includes a mobile device 102, a reward service 104, a network 106 and a location signal source 108. Mobile device 102 is configured to determine its location (and thereby the location of the associated user) based on a location signal from location signal source 108 and may be configured to receive reward offers from reward service 104. In some embodiments, mobile device 102 may be configured to determine a travel route (i.e., map a route) and to provide the mapped route to the reward service 104. The reward service 104 is configured to provide reward offers to mobile device 102, based on the mapped route and user interest profile uploaded to the reward service 104. The reward service 104 may be a cloud-based service that includes a plurality of servers and storage devices. Network 106 is configured to couple mobile device 102 to reward service 104 and may include wired and/or wireless networks, including, but not limited to the Wi-Fi, the internet, and/or cellular telephone networks such as 2G, 3G and 4G, including satellite.

Mobile device 102 may include various hardware platforms that are capable of wired and/or wireless communication and may be capable of receiving a location signal and determining a device location based on the location signal. For example, mobile device 102 may include, but is not limited to, any handheld computing device, including, but not limited to, mobile telephones, cellular telephones, satellite telephones, feature phones, smart phones (e.g., iPhones®, Android®-based phones, Blackberries®, Symbian®-based phones, Palm®-based phones, etc.), tablet computers, notebook computers, ultraportable computers, ultramobile computers, netbook computers, subnotebook computers, personal digital assistants, enterprise digital assistants, mobile internet devices and personal navigation devices. Feature phones may be understood as having fewer functions than smart phones.

Mobile device 102 includes one or more processor(s) 110, communication module 112, display 114, location module 116 and reward module 118. In some embodiments, mobile device 102 may further include mapping module 117 and/or interest profile(s) 119. Processor(s) 110 are configured to perform operations of one or more applications and/or modules as described herein. Communication module 112 is configured to couple mobile device 102 to reward service 104 and/or network 106. Communication module 112 may be configured to communicate using one or more communication protocols, wired (e.g., Universal Serial Bus (USB), Ethernet, Firewire, etc.) and/or wireless including satellite (e.g., NFC, RFID, Wi-Fi, Bluetooth, 2G, 3G, 4G, etc.).

Display 114 includes any device configured to display text, maps, pop-ups, images, user interfaces, graphics, etc. Display 114 may be integrated within mobile device 102 or may interact with the mobile device via wired or wireless communication such as described in the above examples regarding communication module 112. In one embodiment, display 114 is configured to display at least a portion of a mapped route and to display a reward offer as an overlay on the mapped route. The display 114 may be further configured to display a reward offer summary as described herein.

Location module 116 is configured to determine a location of mobile device 102 based on one or more location signals. In an embodiment, location module 116 may be configured to receive location signal(s) from signal source 108 and to determine the location of mobile device 102 based on the received location signal(s). For example, signal source 108 may include one or more components of the Global Positioning System (GPS). GPS is a satellite-based navigation system that transmits location signal(s) to earth. The location signal(s) and triangulation techniques may then be used to determine a device's location. In another embodiment, location module 116 may be configured to determine location based on a cellular-based data communication technologies, e.g., second generation (2G), third generation (3G), fourth generation (4G) cellular-based data communication technologies. In this embodiment, location module 116 may be configured to determine location based on relative signal strengths of a plurality of signals received from a plurality of cellular communication transmitters (“cell towers”). In another embodiment, location module 116 may be configured to determine location based on Wi-Fi wireless data communication technology. In this embodiment, location module 116 may be configured to determine location based on an address associated with a Wi-Fi access point.

Mapping module 117 is configured to generate a travel route for mobile device 102 based on a starting location and at least one destination location. Mapping module 117 may generate the travel route based on locally stored map data and/or may be configured to access a mapping service via, e.g., network 106, in order to generate the travel route. Mapping module 117 may include custom, proprietary, known and/or after-developed mapping processing code (or instruction sets) that are generally well-defined and operable to generate travel routes based on a starting location and at least one destination.

Reward module 118 is configured to manage operations associated with the reward offer system for mobile device 102. Reward module 118 is configured to receive reward offers from reward service 104 and to display reward offers on display 114. Reward offers may include discount coupons, free items, two-for-one offers, discount services, etc. The reward offers are configured to provide incentives to a user to deviate a distance from a mapped travel route to visit a place of interest (e.g., restaurants, retail stores, specialty stores, tourist attractions, etc.). The reward offers may be time-limited, i.e., valid for a number of hours, a day, a number of days, etc. Reward offers may be displayed on display 114 when mobile device 102 (or a related device) approaches within a distance of the place of interest. The distance may correspond to a deviation distance plus a notice distance. The distance and place of interest may be based on data stored in interest profile(s) 119.

Interest profile(s) 119 are configured to relate businesses and attractions that are places of interest to the user to a distance the user is willing to travel (“deviation distance”) off a mapped route to go to the place of interest. Businesses and attractions may be specified according to categories (e.g., retail stores) as well as detail tags (e.g., collectible books store, 3 to 4 star Italian restaurant). Categories may include retail stores, restaurants, tourist attractions, etc. Detail tags may include specialty stores, antique book stores, sporting goods stores, ethnic restaurants, historical sites, etc. The categories and detail tags may be used to determine whether a business or attraction exists that is of interest to the user and within the associated deviation distance to a user's mapped route.

The interest profile(s) 119 may include predefined, preselected and/or customized records of businesses and attractions of interest and associated deviation distances. For example, a user may be willing to travel twenty miles off of a mapped route to visit a sporting goods store and may be willing to travel thirty miles to visit an antique bookstore. The interest profile(s) 119 may thus include sporting goods store with an associated distance of twenty miles and antique bookstore with an associated distance of thirty miles. The interest profile may then be used by reward module 118 and reward service 104 to provide reward offers as the user travels along a mapped route that correspond to the selected interest profile.

Reward service 104 includes processor(s) 120, a communication module 122, memory 124 and reward service module 126. Processor(s) 120 are configured to perform operations of one or more applications and/or modules as described herein. Communication module 122 is configured to couple reward service 104 to one or more mobile devices, e.g., mobile device 102, and/or network 106. Communication module 122 may be configured to communicate using one or more communication protocols, wired (e.g., Universal Serial Bus (USB), Ethernet, Firewire, etc.) and/or wireless (e.g., NFC, RFID, Wi-Fi, Bluetooth, 2G, 3G, 4G, etc.). Memory 124 is configured to store data, and/or one or more databases including, but not limited to, reward offers database 128, a plurality of user interest profiles 130 and user mapped route data 132.

Reward service module 126 is configured to manage a reward offer system consistent with the present disclosure. Reward service module 126 is configured to maintain the reward offers database 128 and the user profiles 130. Reward service module 126 is configured to receive reward offers from businesses and attractions and to store related information in the reward offers database 128. For example the reward offers database 128 may include a plurality of records associated with reward offers. Each record may include a name, address and GPS coordinates of the business or attraction, business or attraction category and associated detail tags, active reward offers including type of reward, amount, duration and a deviation distance. The business and attraction information may be used to match a business or attraction in the reward offers database 128 to a user's uploaded interest profile. A plurality of reward offers may be included for a selected business or attraction with varying deviation distances. For example, a 40% off coupon may be offered for a user willing to deviate 50 miles from a mapped route and a 20% coupon may be offered for a user willing to deviate 30 miles from a mapped route. In this manner, reward offers may be based on deviation distance.

Reward service 104 is further configured to provide reward offers to a user via, e.g., mobile device 102, based on a user interest profile stored in user interest profile(s) 130 and user mapped route data 132. For example, a user interest profile, user mapped route data and a user identifier (e.g., a mobile device identifier) may be uploaded after a route is mapped. Reward service 104 may then determine whether any reward offers correspond to the user's interest profile for the mapped route. Reward service 104 may make this determination when the user interest profile and mapped route data are uploaded and/or may repeat the determination as the user travels along the mapped route. If corresponding reward offers are found, reward service module 126 is configured to provide the reward offer to a user's mobile device, e.g., mobile device 102, as described herein.

Thus, reward offer system 100 is configured to determine available reward offers based on a user's mapped route and selected interest profile. Reward offers that match the user's interest profile including, e.g., category and detail tags associated with a business or attraction, and deviation distance may then be provided to the user via, e.g., mobile device 102. In some embodiments, the reward offers may be displayed to a user at a start of a mapped route. In other embodiments, the reward offers may be displayed to the user near a point of deviation from the mapped route. The user may then accept a reward offer and a route may be mapped to the associated place of interest (e.g., based on the GPS coordinates associated with the reward offer). In some embodiments, at completion of the trip or in response to a request from the user, a reward offer summary may be displayed. For example, the reward offer summary may include rewards offered, reward offers redeemed and a total savings for the trip.

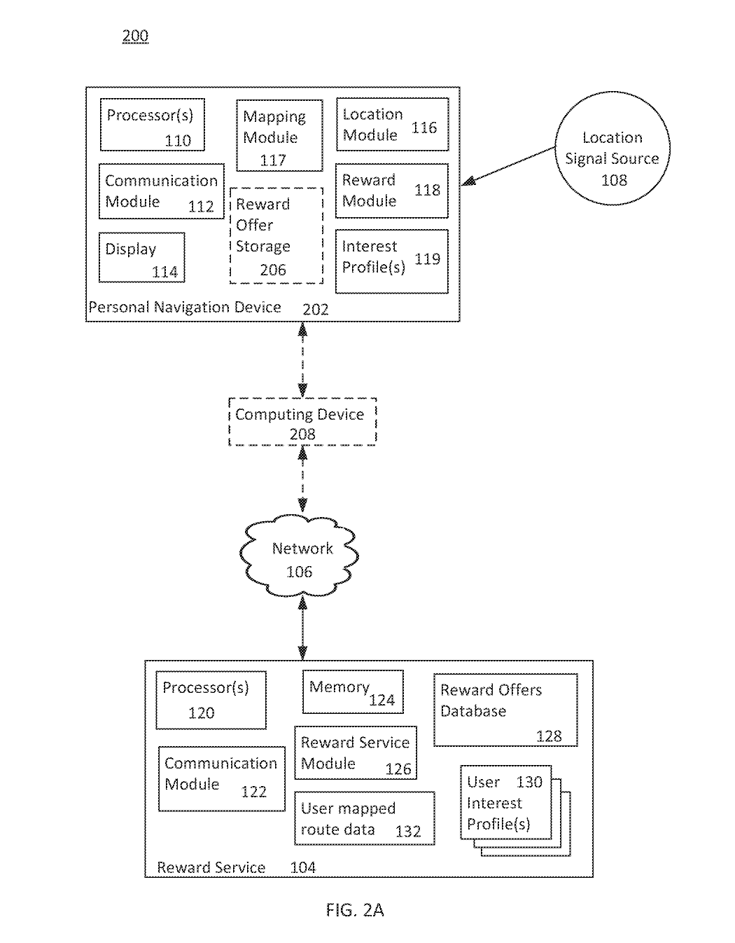

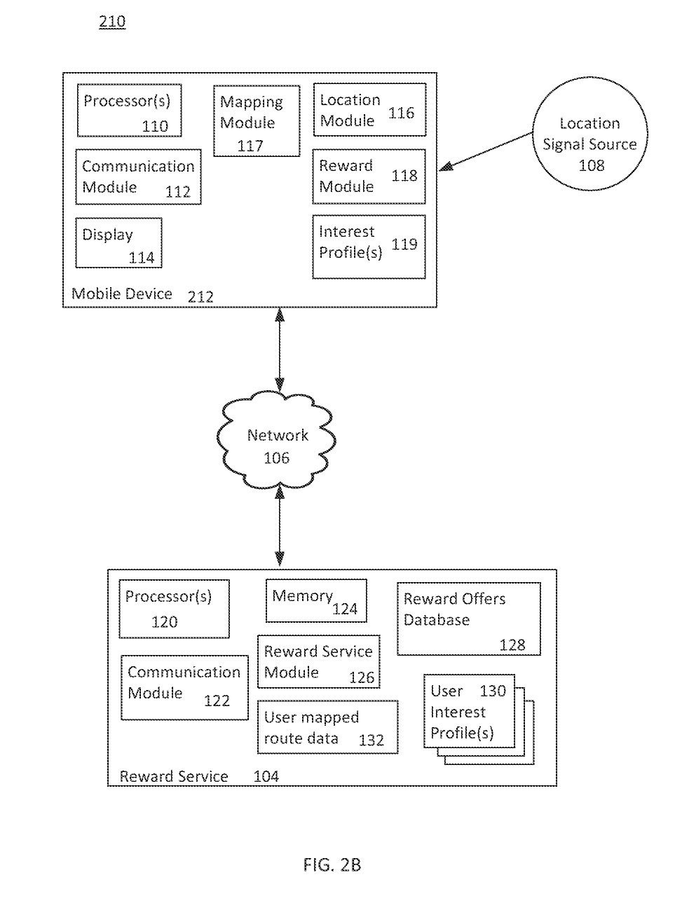

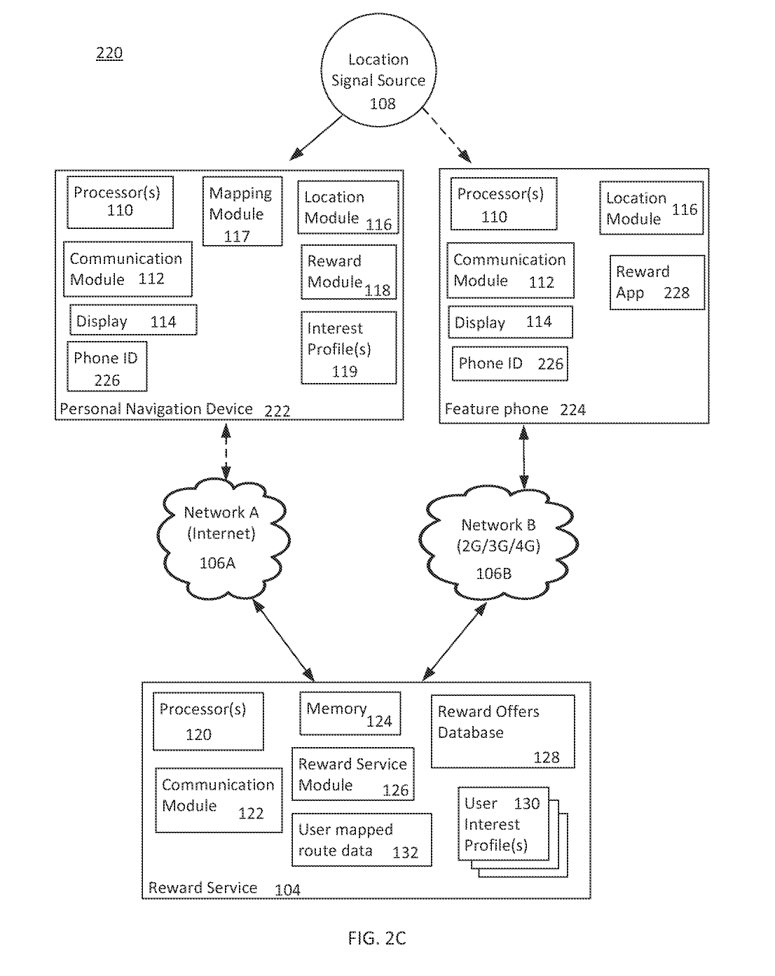

FIGS. 2A through 2C illustrate exemplary reward offer systems, each consistent with at least one embodiment of the present disclosure. FIG. 2A illustrates one example 200 reward offer system consistent with the present disclosure. System 200 includes a personal navigation device 202, network 106, reward service 104, signal source 108 and may include a computing device 208. Personal navigation device 202 corresponds to mobile device 102 of system 100. Personal navigation device 202 includes interest profile(s) 119 and reward offer storage 206. Personal navigation device 202 may include any mobile device configured to generate a travel route based on a starting location and one or more destinations and to determine device location based on a location (e.g., GPS) signal. Specific examples of personal navigation devices include, but are not limited to, TomTom® GPS systems, Magellan® GPS systems and Garmin™ GPS systems.

In this example, personal navigation device 202 may be configured to couple to remote service 104 via computing device 208 and network 106. In other words, personal navigation device 202 may not generally be configured to couple directly to network 106. Communication module 112 may include, for example, a USB interface for connecting to computing device 208 and computing device may then be configured to access reward service 104 via network 106. For example, personal navigation device 202 and mapping module 117 may be configured to download updated mapping data via computing device 208. Reward module 118 may be configured to upload mapped route data and interest profile data to reward service 104 via computing device 208 and may be configured to download and save reward offer(s) that correspond to the mapped route and interest profile data, prior to the user initiating travel.

During the mapped travel, reward module 118 may be configured to monitor the location of personal navigation device 202 (determined, e.g., by location module 116 based on location signal 108) and to display a reward offer on display 114 when the personal navigation device 202 is at or within a notice distance of a deviation point from the mapped route. The deviation point is a point on the mapped route that corresponds to location where a route to the place of interest (e.g., business or attraction included in the interest profile uploaded to remote service 104) associated with the reward offer begins to deviate from the mapped route. The notice distance is configured to provide the user an opportunity to view the reward offer prior to reaching the deviation point.

If the user accepts the reward offer, a new route may then be mapped to the associated place of interest and, after a visit to the place of interest a route may be mapped to return to a next destination on the initially mapped route. If the user does not accept the reward offer, the personal navigation device 202 may be configured to return to displaying route information.

Thus, in the example reward offer system 200 illustrated in FIG. 2A, a personal navigation device that is not directly network enabled may be configured to upload a mapped route and a user selected interest profile to reward service 104 and to download and store associated reward offers. The reward offers may be displayed on display 114 at the start of travel and/or at or near each deviation point whose location is determined based on the location signal from location signal source 108. The user may accept a displayed reward offer and may deviate a deviation distance from the mapped route to visit the place of interest and redeem the reward. In this manner, a user may be offered rewards based on user interests and associated deviation distances. Further, a business or attraction may extend advertising to potential customers who may be willing to travel a distance out of their way to visit the business or attraction if informed of its existence and rewarded for deviating from a mapped route.

FIG. 2B illustrates another example 210 reward offer system consistent with the present disclosure. System 210 includes a mobile device 212, network 106, reward service 104 and signal source 108. Mobile device 212 corresponds to mobile device 102 of system 100. Mobile device 212 includes interest profile(s) 119. Mobile device 212 may include any mobile device configured to generate a travel route based on a starting location and one or more destinations and to determine device location based on a location (e.g., GPS) signal. Mobile device 212 may include personal navigation devices and/or smartphones. For example, mobile device 212 may correspond to a network-enabled GPS system or a smart phone.

In this example, mobile device 212 is configured to couple to remote service 104 via network 106. Communication module 112 may be configured for wired and/or wireless communication, as described herein. Mobile device 212 may be configured to couple to reward service 104 prior to and/or during travel. Reward module 118 may be configured to upload mapped route data and interest profile data to reward service 104 prior to the user initiating travel.

During the mapped travel, reward service module 126 may be configured to monitor the location of mobile device 212, determined, e.g., by location module 116 based on location signal 108, and communicated to reward service 104 via network 106. The reward service module 126 may then query reward offers database 128 to determine whether any reward offers are available that meet the user's uploaded interest profile stored in user interest profile(s) 130. The reward service module 126 may query reward offers database 128 upon receiving the uploaded mapped route data and user profile data and/or during the user's travel. Querying the reward offers database 128 during travel may be triggered by a route change of mobile device 212 and/or by expiration of a time interval (i.e., may be periodic). In this manner, the reward service module 126 is configured to access the most up-to-date reward offer information and to timely display the reward offer(s). Reward service module 126 may be configured to display a reward offer on display 114 when the mobile device 212 is at or within a notice distance of a deviation point from the mapped route. If the user accepts the reward offer, a new route may then be mapped to the associated place of interest and, after a visit to the business or attraction a route may be mapped to return to a next destination on the initially mapped route. If the user does not accept the reward offer, the mobile device 212 may be configured to return to displaying route information.

Thus, in the example reward offer system 210 illustrated in FIG. 2B, a network enabled mobile device 212 may be configured to upload a mapped route and a user selected interest profile to reward service 104 and to receive reward offers from the reward service 104 during the associated travel. In this manner, a user may be offered up-to-date rewards based on user interests and associated deviation distances. Further, based on a detected location of mobile device 212, reward service module 126 may be configured to adjust a reward offer, if a user declines an initial offer. For example, a reward offer may be increased and the user provided another opportunity to deviate from the user's mapped route. Advertisers may then be able to determine appropriate reward offers based on user response data.

FIG. 2C illustrates another example 220 reward offer system consistent with the present disclosure. In this example, a personal navigation device may be configured to map the route and a feature phone may be configured to receive reward offers. System 220 includes a personal navigation device 222 and a feature phone 224, networks 106A and 106B, reward service 104 and signal source 108. In this example, personal navigation device 222 is not network-enabled, similar to the personal navigation device 202 of FIG. 2A. Feature phone 224 may not be capable of mapping a route. Thus, a combination of personal navigation device 222 and feature phone 224 may be utilized to implement a reward offer system consistent with an embodiment of the present disclosure.

Personal navigation device 222 may be configured to communicate with remote service 104 prior to travel via network 106A (e.g., internet) as described with respect to personal navigation device 202. Personal navigation device 222 may include a phone identifier store configured to store phone ID 226 corresponding to a unique identifier associated with feature phone 224. Personal navigation device 222 may be configured to upload the phone ID 226 with the mapped route data and the user interest profile prior to travel.

After travel is initiated, the user's location may be determined based on a location of feature phone 224 communicated to reward service 104 by, for example, reward app 228. For example, the location of the feature phone 224 may be determined based on relative signal strengths of cellular communication signals from a plurality of cellular telephone towers. In another example, the feature phone 224 may be configured to receive a location signal (e.g., GPS) from location signal source 108. In another example, the feature phone 224 may be configured to communicate locally (e.g., via Bluetooth) with the personal navigation device 222 to determine their location. The feature phone 224, using reward app 228, may then transmit the location and phone OD 226 to reward service 104 via network 106B. The reward service module 126 may then provide reward offers to feature phone 224 based on the determined location and stored user profile. Feature phone 224 may then display the reward offers to the user.

Thus, in this example, both a personal navigation device (non-network enabled) and a feature phone may be used to map a route, select a user interest profile, provide mapped route data and the user interest profile to reward service 104. The phone ID 226 associated with the feature phone 224 may also be provided to remote service 104. The user's location may then be determined based on a determined location of the feature phone 224 and communicated to the reward service 104 by the feature phone 224. The reward service 104 (using reward service module 126) may then provide reward offers to the feature phone 224 via network 106B that may then be displayed to the user. In this manner, two relatively less complicated devices may be configured to provide location information and receive reward offers consistent with an embodiment of the present disclosure.

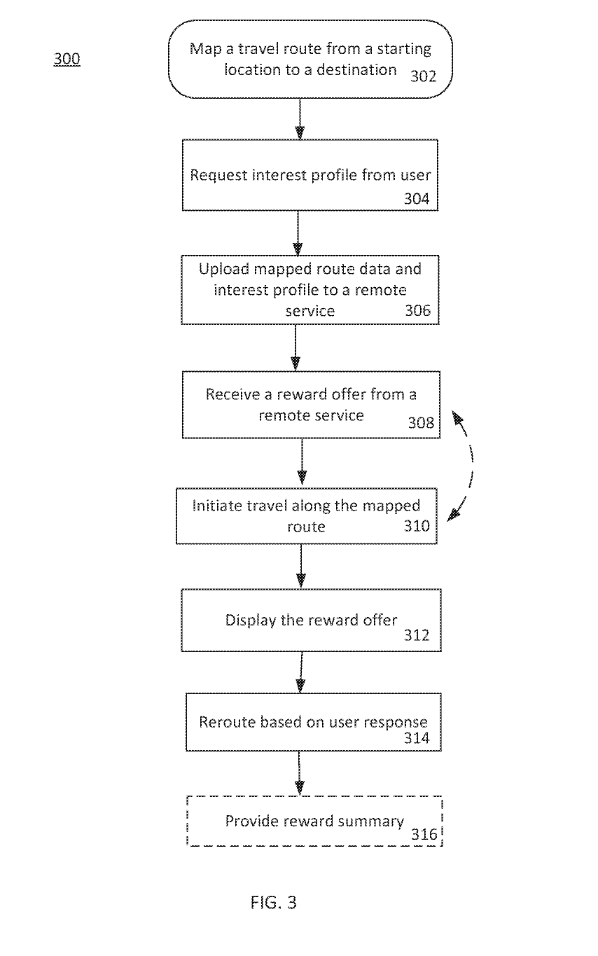

FIG. 3 illustrates a flowchart 300 of exemplary operations consistent with an embodiment of the present disclosure. The operations may be performed, for example, by mobile device 102 and/or the remote service 104. In particular, flowchart 300 depicts exemplary operations configured to provide reward offers, e.g., discount coupons, based on a deviation distance from a mapped travel route and a predefined interest profile while the user is travelling along a mapped route.

The operations of flowchart 300 may begin with operation 302, mapping a travel route from a starting location to a destination. For example, a user may launch a mapping application on an associated mobile device. Operation 304 includes requesting in interest profile from a user. User interest profiles may include places of interest (e.g., businesses and attractions) for a user and an associated deviation distance that the user is willing to travel from a mapped route to visit the place of interest. The user may select from a previously stored interest profile or generate a new profile when responding to a request for an interest profile.

Mapped route data and the user interest profile may be uploaded to a remote service at operation 306. A reward offer may be received from remote service at operation 308 and travel along the mapped route may be initiated at operation 310. The reward offer may be displayed at operation 312 and travel may be rerouted (or not) based on the user response. A reward summary may then be provided at operation 316. The reward summary may be provided in response to a request from the user or after arrival at as destination. The reward summary may include rewards offered, rewards redeemed and savings associated with the redeemed rewards.

It should be noted that, depending on the embodiment, operation 310, initiating travel may occur prior to operation 308, receiving a reward offer. For example, for system 200, the reward offer may be received and stored prior to travelling and then displayed to the user during the travel. In another example, e.g., system 210, the reward offer(s) may be received during the travel and displayed to the user when received.

Thus, the operations of flowchart 300 are configured to provide reward offers to a user based on a user interest profile that includes places of interest and associated deviation distances. The reward offers are configured to be displayed to the user while the user is travelling along a mapped route.

While FIG. 3 illustrates various operations according one embodiment, it is to be understood that not all of the operations depicted in FIG. 3 are necessary for other embodiments. Indeed, it is fully contemplated herein that in other embodiments of the present disclosure, the operations depicted in FIG. 3 and/or other operations described herein may be combined in a manner not specifically shown in any of the drawings, but still fully consistent with the present disclosure. Thus, claims directed to features and/or operations that are not exactly shown in one drawing are deemed within the scope and content of the present disclosure.

As used in any embodiment herein, the term “app” may be embodied in code or instructions that may be executed on programmable circuitry such as a host processor or other programmable circuitry.

As used in any embodiment herein, the term “module” may refer to an app, software, firmware and/or circuitry configured to perform any of the aforementioned operations. Software may be embodied as a software package, code, instructions, instruction sets and/or data recorded on non-transitory computer readable storage medium. Firmware may be embodied as code, instructions or instruction sets and/or data that are hard-coded (e.g., nonvolatile) in memory devices.

“Circuitry”, as used in any embodiment herein, may comprise, for example, singly or in any combination, hardwired circuitry, programmable circuitry such as computer processors comprising one or more individual instruction processing cores, state machine circuitry, and/or firmware that stores instructions executed by programmable circuitry. The modules may, collectively or individually, be embodied as circuitry that forms part of a larger system, for example, an integrated circuit (IC), system on-chip (SoC), desktop computers, laptop computers, tablet computers, servers, smart phones, etc.

Any of the operations described herein may be implemented in a system that includes one or more storage mediums having stored thereon, individually or in combination, instructions that when executed by one or more processors perform the methods. Here, the processor may include, for example, a server CPU, a mobile device CPU, and/or other programmable circuitry. Also, it is intended that operations described herein may be distributed across a plurality of physical devices, such as processing structures at more than one different physical locations. The storage medium may include any type of tangible medium, for example, any type of disk including hard disks, floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories. Solid State Disks (SSDs), magnetic or optical cards, or any type of media suitable for storing electronic instructions. Other embodiments may be implemented as software modules executed by a programmable control device. The storage medium may be non-transitory.

Mobile device 102 may be configured to communicate with network 106 and/or server 104 using a variety of communication protocols. The communications protocols may include but are not limited to wireless communications protocols, such as NFC, RFID, Wi-Fi, Bluetooth, 3G, 4G and/or other communication protocols. The Wi-Fi protocol may comply or be compatible with the 802.11 standards published by the Institute of Electrical and Electronics Engineers (IEEE), titled “IEEE 802.11-2007 Standard, IEEE Standard for Information Technology-Telecommunications and Information Exchange Between Systems-Local and Metropolitan Area Networks-Specific Requirements—Part 11: Wireless LAN Medium Access Control (MAC) and Physical Layer (PHY) Specifications” published, Mar. 8, 2007, and/or later versions of this standard.

The NEC and/or RFID communication signal and/or protocol may comply or be compatible with one or more NEC and/or RFID standards published by the International Standards Organization (ISO) and/or the International Electrotechnical Commission (IEC), including ISO/IEC 14443, titled: Identification cards—Contactless integrated circuit cards—Proximity cards, published in 2008; ISO/IEC 15693: Identification cards—Contactless integrated circuit cards—Vicinity cards, published in 2006, ISO/IEC 18000, titled: Information technology—Radio frequency identification for item management, published in 2008; and/or ISO/IEC 18092, titled: Information technology—Telecommunications and information exchange between systems—Near Field Communication—Interface and Protocol, published in 2004; and/or later versions of these standards.

The Bluetooth protocol may comply or be compatible with the 802.15.1 standard published by the IEEE, titled “IEEE 802.15.1-2005 standard, IEEE Standard for Information technology—Telecommunications and information exchange between systems—Local and metropolitan area networks—Specific requirements Part 15.1: Wireless Medium Access Control (MAC) and Physical Layer (PITY) Specifications for Wireless Personal Area Networks (W Pans)”, published in 2005, and/or later versions of this standard.

The 3G protocol may comply or be compatible with the International Mobile Telecommunications (IMT) standard published by the International Telecommunication Union (ITU), titled “IMT-2000”, published in 2000, and/or later versions of this standard. The 40 protocol may comply or be compatible with IMT standard published by the ITU, titled “IMT-Advanced”, published in 2008, and/or later versions of this standard.

For example, network 106 may comprise a packet switched network. Mobile device 102 may be capable of communicating with the server 104 using a selected packet switched network communications protocol. One exemplary communications protocol may include an Ethernet communications protocol which may be capable permitting communication using a Transmission Control Protocol/Internet Protocol (TCP/IP). The Ethernet protocol may comply or be compatible with the Ethernet standard published by the Institute of Electrical and Electronics Engineers (IEEE) titled “IEEE 802.3 Standard”, published in March, 2002 and/or later versions of this standard. Alternatively or additionally, mobile device 102 may be capable of communicating with server 104, using an X.25 communications protocol. The X.25 communications protocol may comply or be compatible with a standard promulgated by the International Telecommunication Union-Telecommunication Standardization Sector (ITU-T). Alternatively, or additionally, mobile device 102 may be capable of communicating with server 104, using a frame relay communications protocol. The frame relay communications protocol may comply or be compatible with a standard promulgated by Consultative Committee for International Telegraph and Telephone (CCITT) and/or the American National Standards Institute (ANSI). Alternatively or additionally, mobile device 102 may be capable of communicating with server 104, using an Asynchronous Transfer Mode (ATM) communications protocol. The ATM communications protocol may comply or be compatible with an ATM standard published by the ATM Forum titled “ATM-MPLS Network Interworking 1.0” published August 2001, and/or later versions of this standard. Of course, different and/or after-developed connection-oriented network communication protocols are equally contemplated herein.

Thus, the present disclosure provides an apparatus, method and system for providing reward offers based on a deviation distance from a mapped travel route. A method and system are configured to provide a user reward offers based on a predefined interest profile while the user is travelling along a mapped route. The interest profile may include a plurality of businesses and/or attractions that are places of interest to the user and an associated deviation distance for each business or attraction. The reward offers are configured to provide the user incentive to deviate from the mapped route in order to go to a place of interest to the user. The reward offers are further configured to provide a targeted and extended advertising opportunity for businesses to attract travelers who are on a route that does not directly go by their businesses. Thus, both the user and the business may benefit from a method and system consistent with the present disclosure.

According to one aspect there is provided a mobile device. The mobile device may include a location module configured to determine a location of the mobile device and a mapping module configured to map a travel route from a first location to a second location. The mobile device of this example may also include a display configured to display at least a portion of the travel route and a reward module. The reward module of this example is configured to request an interest profile from a user and receive a reward offer related to the interest profile and the travel route. The interest profile of this example may comprise a place of interest and a deviation distance. The reward offer of this example is configured to cause the user to deviate a deviation distance from the travel route to redeem the reward.

Another example mobile device includes the forgoing components and the reward module is further configured to upload the interest profile and route data related to the travel route to a remote service coupled to the mobile device.

Another example mobile device includes the forgoing components and the display is configured to display the reward offer to the user when the location of the mobile device is at least the deviation distance from a location of a business or attraction that corresponds to the place of interest.

Another example mobile device includes the forgoing components and the reward module is configured to monitor a current location of the mobile device along the travel route and to display the reward offer based on the current location.

Another example mobile device includes the forgoing components and the display is configured to display a reward summary. The reward summary of this example comprises a listing of reward offers, a listing of redeemed reward offers and a savings amount based on the listing of redeemed reward offers.

Another example mobile device includes the forgoing components and the location module is configured to determine the location of the mobile device based on a GPS (Global Positioning System) signal or relative signal strengths of a plurality of cellular communication signals.

Another example mobile device includes the forgoing components and the place of interest corresponds to a business or an attraction.

Another example mobile device includes the forgoing components and a value of the reward offer is related to the deviation distance.

According to another aspect there is provided a system. The system may include a mobile device and a remote service coupled to the mobile device by a network. The mobile device may include a location module configured to determine a location of the mobile device and a mapping module configured to map a travel route from a first location to a second location. The mobile device of this example may also include a display configured to display at least a portion of the travel route and a reward module configured to request an interest profile from a user. The interest profile of this example, may comprise a place of interest and a deviation distance. The remote service may be configured to provide a reward offer related to the interest profile and the travel route to the mobile device. The reward offer of this example is configured to cause the user to deviate a deviation distance from the travel route to redeem the reward.

Another example system includes the forgoing components and the reward module is further configured to upload the interest profile and route data related to the travel route to the remote service.

Another example system includes the forgoing components and the remote service is configured to provide the reward offer to the mobile device and the display is configured to display the reward offer to the user when the location of the mobile device is at least the deviation distance from a location of a business or attraction that corresponds to the place of interest.

Another example system includes the forgoing components and the reward module is configured to monitor a current location of the mobile device along the travel route and to display the reward offer based on the current location.

Another example system includes the forgoing components and the display is configured to display a reward summary. The reward summary of this example may comprise a listing of reward offers, a listing of redeemed reward offers and a savings amount based on the listing of redeemed reward offers.

Another example system includes the forgoing components and the location module is configured to determine the location of the mobile device based on a GPS (Global Positioning System) signal or relative signal strengths of a plurality of cellular communication signals.

Another example system includes the forgoing components and the place of interest corresponds to a business or an attraction.

Another example system includes the forgoing components and a value of the reward offer is related to the deviation distance.

According to another aspect there is provided a method. The method may include mapping a travel route from a first location to a second location using a mobile device. The mobile device of this example is configured to display at least a portion of the travel route. The method of this example also includes requesting an interest profile from a user and receiving a reward offer related to the interest profile and the travel route by the mobile device. The interest profile of this example may comprise a place of interest and a deviation distance. The reward offer of this example is configured to cause the user to deviate a deviation distance from the travel route to redeem the reward.

Another example method includes the forgoing operations and further includes uploading the interest profile and route data related to the travel route to a remote service.

Another example method includes the forgoing operations and further includes providing the reward offer to the mobile device and displaying the reward offer to the user when the location of the mobile device is at least the deviation distance from a location of a business or attraction that corresponds to the place of interest.

Another example method includes the forgoing operations and further includes monitoring a current location of the mobile device along the travel route and displaying the reward offer based on the current location.

Another example method includes the forgoing operations and farther includes displaying a reward summary. The reward summary of this example may comprise a listing of reward offers, a listing of redeemed reward offers and a savings amount based on the listing of redeemed reward offers.

Another example method includes the forgoing operations and further includes determining the location of the mobile device based on a GPS (Global Positioning System) signal or relative signal strengths of a plurality of cellular communication signals.

Another example method includes the forgoing operations and farther includes that the place of interest corresponds to a business or an attraction.

Another example method includes the forgoing operations and further includes that a value of the reward offer is related to the deviation distance.

According to another aspect there is provided a system. The system may include one or more storage mediums having stored thereon, individually or in combination, instructions that when executed by one or more processors result in the following operations comprising mapping a travel route from a first location to a second location using a mobile device. The mobile device of this example is configured to display at least a portion of the travel route. The operations of this example may also include requesting an interest profile from a user. The interest profile of this example may comprise a place of interest and a deviation distance. The operations of this example may further include receiving a reward offer related to the interest profile and the travel route by the mobile device. The reward offer of this example is configured to cause the user to deviate a deviation distance from the travel route to redeem the reward.

Another example system includes instructions that when executed by one or more processors result in the forgoing operations and also includes the following additional operation: uploading the interest profile and route data related to the travel route to a remote service.

Another example system includes instructions that when executed by one or more processors result in the forgoing operations and also includes the following additional operation: providing the reward offer to the mobile device and displaying the reward offer to the user when the location of the mobile device is at least the deviation distance from a location of a business or attraction that corresponds to the place of interest.

Another example system includes instructions that when executed by one or more processors result in the forgoing operations and also includes the following additional operation: monitoring a current location of the mobile device along the travel route and displaying the reward offer based on the current location.

Another example system includes instructions that when executed by one or more processors result in the forgoing operations and also includes the following additional operation: displaying a reward summary. The reward summary of this example may comprise a listing of reward offers, a listing of redeemed reward offers and a savings amount based on the listing of redeemed reward offers.

Another example system includes instructions that when executed by one or more processors result in the forgoing operations and also includes the following additional operation: determining the location of the mobile device based on a GPS (Global Positioning System signal or relative signal strengths of a plurality of cellular communication signals.

Another example system includes instructions that when executed by one or more processors result in the forgoing operations and also includes that the place of interest corresponds to a business or an attraction.

Another example system includes instructions that when executed by one or more processors result in the forgoing operations and also includes that a value of the reward offer is related to the deviation distance.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents.

1-27. (canceled)

28. A mobile device comprising:
a location module configured to determine a location of the mobile device;
a mapping module configured to map a travel route from a first location to a second location;
a display configured to display at least a portion of the travel route; and
a reward module configured to:
request an interest profile from a user, the interest profile comprising a place of interest and a deviation distance, and
receive a reward offer related to the interest profile and the travel route, the reward offer configured to cause the user to deviate a deviation distance from the travel route to redeem the reward.

29. The mobile device of claim 28, wherein the reward module is further configured to:
upload the interest profile and route data related to the travel route to a remote service coupled to the mobile device.

30. The mobile device of claim 28, wherein the display is configured to display the reward offer to the user when the location of the mobile device is at least the deviation distance from a location of a business or attraction that corresponds to the place of interest.

31. The mobile device of claim 28, wherein the reward module is configured to monitor a current location of the mobile device along the travel route and to display the reward offer based on the current location.

32. The mobile device of claim 28, wherein the display is configured to display a reward summary, the reward summary comprising a listing of reward offers, a listing of redeemed reward offers and a savings amount based on the listing of redeemed reward offers.

33. The mobile device of claim 28, wherein the location module is configured to determine the location of the mobile device based on a GPS (Global Positioning System) signal or relative signal strengths of a plurality of cellular communication signals.

34. The mobile device of claim 28, wherein the place of interest corresponds to a business or an attraction.

35. The mobile device of claim 28, wherein a value of the reward offer is related to the deviation distance.

36. A system comprising:
a mobile device comprising:
a location module configured to determine a location of the mobile device,
a mapping module configured to map a travel route from a first location to a second location,
a display configured to display at least a portion of the travel route, and
a reward module configured to request an interest profile from a user, the interest profile comprising a place of interest and a deviation distance; and
a remote service coupled to the mobile device by a network, the remote service configured to provide a reward offer related to the interest profile and the travel route to the mobile device, the reward offer configured to cause the user to deviate a deviation distance from the travel route to redeem the reward.

37. The system of claim 36, wherein the reward module is further configured to:
upload the interest profile and route data related to the travel route to the remote service.

38. The system of claim 36, wherein the remote service is configured to provide the reward offer to the mobile device and the display is configured to display the reward offer to the user when the location of the mobile device is at least the deviation distance from a location of a business or attraction that corresponds to the place of interest.

39. The system of claim 36, wherein the reward module is configured to monitor a current location of the mobile device along the travel route and to display the reward offer based on the current location.

40. The system of claim 36, wherein the display is configured to display a reward summary, the reward summary comprising a listing of reward offers, a listing of redeemed reward offers and a savings amount based on the listing of redeemed reward offers.

41. The system of claim 36, wherein the location module is configured to determine the location of the mobile device based on a GPS (Global Positioning System) signal or relative signal strengths of a plurality of cellular communication signals.

42. The system of claim 36, wherein the place of interest corresponds to a business or an attraction.

43. The system of claim 36, wherein a value of the reward offer is related to the deviation distance.

44. A method comprising:
mapping a travel route from a first location to a second location using a mobile device, the mobile device configured to display at least a portion of the travel route;
requesting an interest profile from a user, the interest profile comprising a place of interest and a deviation distance; and
receiving a reward offer related to the interest profile and the travel route by the mobile device, the reward offer configured to cause the user to deviate a deviation distance from the travel route to redeem the reward.

45. The method of claim 44, further comprising:
uploading the interest profile and route data related to the travel route to a remote service.

46. The method of claim 44, further comprising:
providing the reward offer to the mobile device and displaying the reward offer to the user when the location of the mobile device is at least the deviation distance from a location of a business or attraction that corresponds to the place of interest.

47. The method of claim 44, further comprising:
monitoring a current location of the mobile device along the travel route and displaying the reward offer based on the current location.

48. The method of claim 44, further comprising:
displaying a reward summary, the reward summary comprising a listing of reward offers, a listing of redeemed reward offers and a savings amount based on the listing of redeemed reward offers.

49. The method of claim 44, further comprising:
determining the location of the mobile device based on a GPS (Global Positioning System) signal or relative signal strengths of a plurality of cellular communication signals.

50. The method of claim 44, wherein the place of interest corresponds to a business or an attraction.

51. The method of claim 44, wherein a value of the reward offer is related to the deviation distance.

52. A system comprising one or more storage mediums having stored thereon, individually or in combination, instructions that when executed by one or more processors result in the following operations comprising:
mapping a travel route from a first location to a second location using a mobile device, the mobile device configured to display at least a portion of the travel route;
requesting an interest profile from a user, the interest profile comprising a place of interest and a deviation distance; and
receiving a reward offer related to the interest profile and the travel route by the mobile device, the reward offer configured to cause the user to deviate a deviation distance from the travel route to redeem the reward.

53. The system of claim 52, wherein the instructions that when executed by one or more processors results in the following additional operations:
uploading the interest profile and route data related to the travel route to a remote service.

54. The system of claim 52, wherein the instructions that when executed by one or more processors results in the following additional operations:
providing the reward offer to the mobile device and displaying the reward offer to the user when the location of the mobile device is at least the deviation distance from a location of a business or attraction that corresponds to the place of interest.

55. The system of claim 52, wherein the instructions that when executed by one or more processors results in the following additional operations:
monitoring a current location of the mobile device along the travel route and displaying the reward offer based on the current location.

56. The system of claim 52, wherein the instructions that when executed by one or more processors results in the following additional operations:
displaying a reward summary, the reward summary comprising a listing of reward offers, a listing of redeemed reward offers and a savings amount based on the listing of redeemed reward offers.

57. The system of claim 52, wherein the instructions that when executed by one or more processors results in the following additional operations:
determining the location of the mobile device based on a GPS (Global Positioning System) signal or relative signal strengths of a plurality of cellular communication signals.

58. The system of claim 52, wherein the place of interest corresponds to a business or an attraction.

59. The system of claim 52, wherein a value of the reward offer is related to the deviation distance.
